(19) United States
(12) Patent Application Publication
(10) Pub. No.: US 2005/0105526 A1
(43) Pub. Date: May 19, 2005

(54) Method for traversing network address translators for SIP-signaled sessions

(75) Inventors: Martin Stiemerling, Heidelberg (DE); Marcus Brunner, Heidelberg (DE); Miguel Martin Lopez, Heidelberg (DE)

Correspondence Address: YOUNG & THOMPSON, 745 SOUTH 23RD STREET, 2ND FLOOR, ARLINGTON, VA, 22202, US

(73) Assignee: NEC CORPORATION, TOKYO (JP)

(21) Appl. No.: 10/990,437

(22) Filed: Nov. 18, 2004

(30) Foreign Application Priority Data
Nov. 18, 2003 (DE) 10353925.5

(51) Int. Cl. H04L 12/56

(52) U.S. Cl. 370/389

(57) ABSTRACT

A data communication method between hosts belonging to different private networks having their own private address spaces, each of the private networks Including at least one network address translator (NAT) and a proxy server accessible from a public address space. The one host obtains an outside-accessible address of the other proxy server and sends a path-coupled signaling packet using the outside-accessible address toward the other proxy server. At the NAT which the path-coupled signaling packet passes in the private network to which the one host belongs, a public address is allocated to the one host. The allocated public address is sent to the other host, allowing the one host to receive data from the other host. When receiving a public address from the other host, data communication is made possible both an the one host and the other host.

### BACKGROUND OF THE INVENTION

1. Field of the Invention

The present invention relates to a data communication method and in particular to a method for exchanging data between two hosts each belonging to private networks with their own address spaces. Specifically, each of the private networks has at least one network address translator (NAT) for translating public addresses into private addresses and vice versa as well as a proxy server accessible from the public address space.

2. Description of the Related Art

Nowadays, exchanging data through the Internet is becoming increasingly important. Frequently the situation arises that two or more hosts wish to exchange data through the public Internet infrastructure although they themselves belong to different internal networks (e.g. enterprise networks), which are operated within different private address spaces. Since a private IP address cannot be contacted from the public Internet, hosts and routers generally cannot communicate with each other.

To overcome this problem, modern networks are usually structured in such a way that, at the border between the network with the private address space and the public Internet, one or more objects—so-called network address translators (NAT)—are provided serving to translate public addresses into private ones and vice-versa. Generally this entails a static address allocation (so-called mapping or also binding) being installed on the NAT for each application server which has to be accessible from the outside i.e. from the public address space. This type of mapping is generally carried out for web servers, e-mail servers, FTP servers, etc. In most cases, not only IP addresses but also port numbers of protocols of higher layers, such as TCP/UDP, are translated.

Modern communication methods frequently require a real-time connection between hosts communicating with each other, as is the case of, for example, Internet telephony (Voice over IF, VoIP) or video conferences. A protocol to set up this type of multimedia sessions is the so-called Session Initiation Protocol (SIP). Here a network with a private address space operates a SIP server (or also a SIP proxy), whereby a static address allocation on the NAT of the private network is carried out, in order to make the SIP proxy accessible from the public address space. Alternatively, the SIP proxy could also run on the NAT itself with a private and a public network interface. In any case, it must be assured that the participants of an SIP signaled conversation who are located in networks with different private address spaces are both registered at a globally accessible SIP proxy. The SIP proxies each have a real private address and an effective public address with both addresses being known to the SIP proxy. In contrast, the hosts communicating with each other in their respective private address space, only have one private address.

SIP signaling usually runs through several SIP proxies from one host to the next. The route along which the signaling packets are transferred is specified in so-called via headers, so that the SIP packets find the same way back to the host initializing the connection.

The SIP signaling enables the (two) hosts communicating with each other to agree on the precise details of the multimedia connection to be established. Problematic is however that even if the SIP signaling functions perfectly, the actual multimedia data for the session does not reach its final target, i.e. the other host, as no static address allocation can be carried out on the NAT for the data communication. This is because the port numbers are selected dynamically on both sides of the data connection and modified by the SIP signaling. Therefore there is no possibility of the NAT predicting which port will be selected, so that the address allocation on the NAT cannot be carried out statically but only on request. In particular, this is a problem for SIP signaled sessions for IP telephony, where users wish to contact other users all over the world.

A well-known method for solving this problem is the use of a so-called intelligent NAT, which recognizes a packet as a SIP packet and reconfigures the contents of the SIP signaling packet in line with the-NAT configuration. If the SIP proxy has no knowledge at all about the NAT, the intelligent NAT exchanges the address of the SIP proxy in the via header with the public IP address of the SIP proxy. Additionally, the NAT allocates a public IP address and port number to the private IF address and port number of the calling host. The NAT replaces the private address and port number in the SIP signaling message with the newly allocated public address and port number. On the way back from the other host—the called party—the NAT of the network of the called party carries out exactly the name steps, i.e. the NAT also replaces the private addresses and port numbers of the SIP proxy and the called party with public information established at the NAT.

Certain types of NATA, especially NATS with built-in firewall functions or with source and target address lists, have to know the public address of the called party before they reveal public IP addresses. In this case, an address and a port must be introduced on the NAT of the caller's network, however the address translation may not be carried out initially. Only once the public address and port number or the other party is known, i.e. or the called party, the address and port number introduced on the NAT of the caller are added to the address translation list, allowing the address translation. These steps only have to be carried out on the caller's side

The method as described above has drawbacks due to several reasons. On the one hand, it is very likely that the data route chosen between the communicating hosts is not optimal. The reason is that a data route generally follows the signaling path at least up to the NAT, i.e. until the private network is left. On the other hand, the private network can only have one access point to the public network, resulting in that the above-described method is not applicable for so-called multi-homed networks. Finally the above-described method is computing intensive and requires a high process performance because the text messages of the SIP signaling have to be subjected to syntax analysis (parsing).

An alternative generic method to exchange data between two hosts is the so-called Middlebox communication, by which the NAT can be contacted according to a configuration protocol which is currently being standardized by the Midcom working group of the Internet Engineering Task Force (IETF). The SIP proxy can contact the NAT to request an address allocation. The SIF proxy must know its own public IF address to write it in the via header. Additionally, the SIP proxy requests an address allocation on the NAT for hosts within the private address space and overwrites the private address and port number with the allocated public IP address and port number. On the way back from the other host—the called party—the SIP proxy of the called party's network carries out exactly the same steps.

The disadvantage of this method is that the SIP proxy must know exactly which NAT it should contact, i.e. the NAT through which the data traffic should run later. In the event that a network has several NATE, this demand is difficult to meet and overall it is very probable that the data traffic is not processed through the optimal path. The data will generally take another path than the configuration protocol, it is thus a path-independent protocol.

### SUMMARY OF THE INVENTION

An object of the present invention is to provide a method to exchange data between two hosts, which is also easily applicable for networks with more than one NAT and in which the data path is selected as favorably as possible.

In accordance with the present invention, two hosts communicate with each other through a public network, wherein the hosts belong to different private networks having their own private address spaces. Each of the private networks includes: at least one network address translator (NAT) performing address translation between a pubic address and a private address; and a proxy server accessible from a public address space.

The data communication method according to the present invention comprises; causing at least one of the hosts to obtain an outside-accessible address of the proxy server of the private network to which the other host belong, and sending a path-coupled signaling packet using the outside-accessible address toward the proxy server of the private network to which the other host belongs; allocating a public address to the one host by the NAT which the path-coupled signaling packet passes in the private network to which the one host belongs; sending the allocated public address from the one host to the other host, allowing the one host to receive data from the other host; and when receiving a public address from the other host, performing data communication between the one host and the other host.

In an embodiment, each of the two hosts sends a path-coupled signaling protocol in the direction of the private network's proxy server of the other host, the direction being determined on the basis of information from the protocol to initialize the connection. A public target address is allocated to each host by the NAT of its private network which passes the path-coupled signaling protocol, under which public target address the host can receive data from the respective other host and which is made known to the other host by means of the protocol to initialize the connection.

It has initially been recognized that it is often a drawback if the data takes the same route as the protocol to initialize the connection. This in particular applies to the case where real time data between two hosts within proximity of each other has to be exchanged, the protocol to initialize the connection however being routed over a topologically distant proxy server. To establish as favorable a data route as possible, in accordance with the invention, a path-coupled signaling protocol is sent from one of the two hosts in the direction of the proxy server of the private network of the respective other host. Path-coupled in this context means that the data later takes the same route as the signaling protocol.

According to an embodiment of the present invention, information from the protocol to initialize the connection can be used to determine in which direction the path-coupled signaling protocol must be sent. In line with the invention, a public address is allocated to each the caller and the called party by the corresponding NAT of their respective network which the path-coupled signaling protocol passes. At this public target address, a host can receive data from the other host. Through the protocol to initialize the connection, the two hosts can inform each other of the public target address allocated to them and then the actual data can be easily exchanged between the two hosts.

The method in accordance with the invention operates with all types of network address translators including those equipped with a firewall. The NATs can be operated fully independently of the protocol to initialize the connection, they only have to recognize the path-coupled signaling protocol. Furthermore, it is advantageous that the proxy servers and the path-coupled signaling protocol are independent of each other, i.e. the proxy servers do not need to recognize the path-coupled signaling protocol.

In addition to the above-mentioned application possibilities, the method in accordance with the invention could also be used to exchange multimedia contents in all types of mobile networks, such as in 2.5G (GPRS), 3G and in future in 4G networks. The use in the context of instant messaging (IM) applications is also conceivable here and it would be particularly advantageous if the IM messages were sent separately between two users.

It should be noted that the method in accordance with the invention is particularly suitable for larger networks with several access points. In such a case, the selected data path will then generally no longer match the route, which the protocol takes to initialize the connection.

It should furthermore be noted that the method in accordance with the invention is not limited to communication between two hosts, but is also applicable for several hosts communicating with each other—for example participants in a video conference.

Finally, it should be noted that a path-coupled signaling protocol to pass NATs and firewalls, as used in the method in accordance with the invention,.is currently being standardized by the NSIS (Next Steps In Signaling) working party of the IETF (Internet Engineering Task Force).

In the following, reference shall be made to the session Initiation Protocol (SIP) for the connection initiation. However, the H.323 protocol or a similar application based signaling protocol could equally be used to initialize the connection.

SIP proxies could ba used as proxy servers configured in such a way that they use their public address in the so-called via header. The public address could then be read out of the via header and the direction in which the path-coupled signaling protocol has to be sent can be set particularly easily in this way.

To attain a high level of practicality, the hosts communicating with each other could not only inform each other of public target addresses but also corresponding port number. In a particularly advantageous way, the respective first SIP proxy, to which the path-coupled signaling protocol is initially sent, could be located topologically near to the respective host issuing the protocol. In particular the respective first proxies within the private networks could be located between the private and public address space. This type of network configuration would ensure that the path-coupled signaling protocol is routed in the right direction and passes the corresponding NAT. In correlation with this, it should be noted that the path-coupled signaling protocol could be routed further and further until it is stopped by a NAT which knows that it is the last one before the public address space. If such a NAT does not exist, the signaling packet could possibly be abandoned.

A particularly safe embodiment could be attained in that, as soon as the called party receives a SIP INVITE packet from the caller, it sends a path-coupled signaling protocol in a first step to the SXP proxy, which is in the first via header of the SIP INVITE packet. The nearer the public IF address, to which the path-coupled signaling protocol is sent, i.e the first SIP proxy where the caller is located, the higher the probability that an optimal data route has been selected. Furthermore, it should be noted that the designation selected of the various SIP messages in the present patent application is based on the standard (RFC 3261) defined by the IETF.

In a next step, a public address could be allocated to the called party at the NAT of its private network, which passes the path-coupled signaling protocol it has issued. In a further step, the caller could be informed of this recently allocated target address through a SIP 200 OK message. Following this, the caller could itself send a path-coupled signaling protocol in the direction of the public address of the called party it has been informed of, with the caller being allocated—a public target address at the corresponding NAT of its private network. In a next step, this address could be communicated to the called party through a SIP REINVITE message. The normal SIP signaling could be continued and finally the data exchange carried out.

With regard to a fast connection set-up, the SIP name of the party called could be translated by the caller by DNS (Domain Name System) resolution into the public address of the respective SIP proxy on which the called party is registered. The caller could then send a path-coupled signaling protocol in the direction of this public address. In a next step, the caller could be allocated a public address to the NAT of its private network which the path-coupled signaling protocol it has issued passes. The called party could be informed of this target address by means of a SIP INVITE message. The NAT of the caller's network can however not provide a firewall function as the public target address established on the NAT is globally accessible to everyone outside the private network.

In a further step, the called party for its part could send a path-coupled signaling protocol to the public target address of the caller, which it is now aware of. The called party could then also be allocated a public address at the NAT of its private network, which is passed by the path-coupled signaling protocol it has issued In a further step, the caller could be informed of this address through a SIP 200 OK message. Following this, the normal SIP signaling could be continued and finally the data could be exchanged between the caller and the called party by means of the public target addresses made known to each other.

In a particularly fast embodiment, in a first step between the caller and the called party a SIP INVITE packet as well as a SIP Ringing packet could be exchanged. In a further step the caller could then send a path-coupled signaling protocol to the SIP proxy which is listed in the last via header of the SI Ringing packet. Accordingly, the party called could send a path-coupled signaling protocol to the SIP proxy, which is listed in the first Via header of the SIP INVITE packet.

In a next step, a public target address could be allocated to each of the caller and the called party at these NATs of their private networks, which pass the path-coupled signaling protocols issued by them. In favor of a particularly fast connection set-up, the public addresses would then already be specified before it is even clear if the called party accepts the call.

Through a SIP 200 OK and a SIP REINVITE message the caller and called party could inform each other of their public target addresses. Following this, the normal SIP signaling could be continued and the data finally exchanged between the caller and the called party.

There are various options to design and develop the teaching of the present invention advantageously. To this end, we herewith refer to the claims following claim 1 and on the other hand to the following explanation of preferred embodiments of the invention on the basis of the drawing. In conjunction with the description of the preferred embodiments of the invention on the basis of the drawing, additionally preferred further developments and advancements of the teaching will be explained.

### BRIEF DESCRIPTION OF THE DRAWINGS

FIG. 1 is a schematic view of a network employing a data communication method according to the present invention, where two hosts communicate with each other, which are each located their own private network;

FIG. 2 is a schematic sequence diagram showing a data communication method according to a first embodiment of the present invention, in which the safety aspect of the data exchange is in the forefront;

FIG. 3 is a schematic sequence diagram showing a data communication method according to a second embodiment of the present invention; and

FIG. 4 is a schematic sequence diagram showing a data communication method according to a third embodiment of the present invention in which a particularly fast connection is achieved.

### DESCRIPTION OF THE PREFERRED EMBODIMENTS

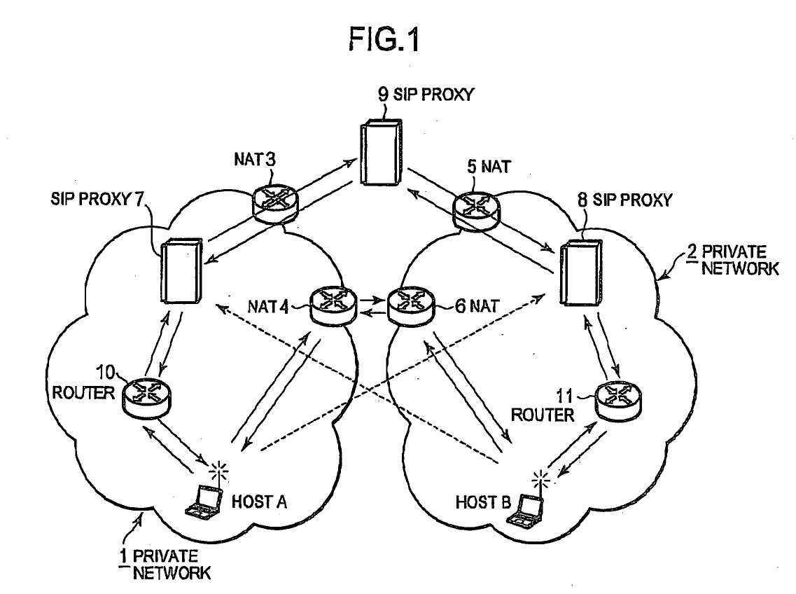

FIG. 1 schematically shows the typical situation of a SIP signaled data communication between two hosts—Host A and Host B, which are located in two different networks 1, 2 each with different private address spaces. The two networks 1, 2 are connected with each other through the public Internet infrastructure, and in the example shown two network address translators 3, 4, and 5, 6 are each provided at the border between the private and the public address space. Both private networks 1 and 2 each operate SIP proxies 7 and 8. Additional SIF proxies 9 of which only one is shown as an example, are located outside the two private networks 1 and 2. Additionally, in FIG. 1 within the networks 1 and 2 located routers 10, 11 are shown.

Each of the hosts A and B is a communication terminal, which is capable of communicating with each other in the framework of Internet telephony, UMTS applications or multimedia communication. Each host is provided with a built-in program-controlled processor on which necessary programs run to implement the signaling and data communication functions, which will be described hereinafter.

Host A—caller—starts the SIP signaling for example by sending a SIP INVITE message to its desired communication partner host B—called party. The SIP signaling runs along the arrows shown in FIG. 1 through the router 10, the SIP proxies 7, 9 and 8 and through the router 11 to the host B. The IP address of host B is generally not known to host A, nor SIP proxy 7, nor SIP proxy 9. Host a solely knows the name of the communication partner desired. The resolution of the name, i.e. the allocation of the name to an IP address, is a function of the SIP signaling and accordingly is carried out in the context of the SIP signaling.

Through the SIP signaling the host A has to inform the host B at which public IP address host A is prepared to receive data from the host B for the session to be created. In a similar way, the host B has to inform the host A at which public IP address the host B receives data. In most cases, not only IP addresses but also port numbers are exchanged.

The problem is that neither host A nor host B have a public IP address and furthermore, do not know which public IP address will be allocated to them when they lave their private networks 1, 2 through NAT 3, 4, 5, or 6. The problem is complicated further by the fact that both hosts still do not even know through which NAT 3, 4, 5, or 6 they will leave their private network 1, 2. Due to these reasons it is not possible for them to inform each other of the necessary information—i.e. their public IP addresses and if necessary port numbers—to carry out data exchange for session-specific data such as multimedia data or Voice-over-IP data between these addresses.

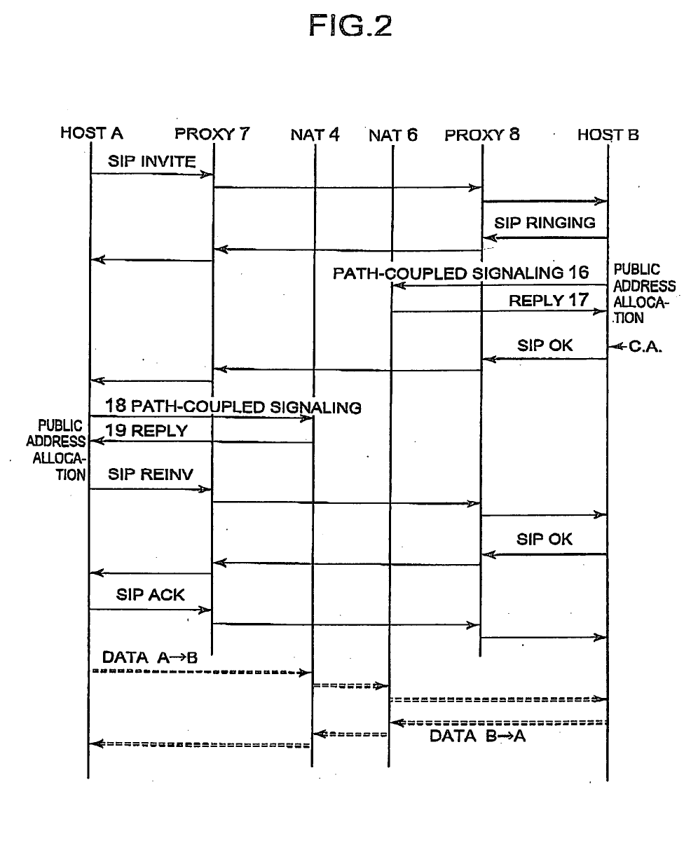

In order to solve the above problems, as described below, each of the hosts A and B can send a path-coupled signaling packet toward the SIP proxy of the other private network where the communication partner is located, which is shown by dashed lines in FIG. 1. The path-coupled signaling packet addressed to the SIP proxy of the other private network will be optimally routed in the private network to reach a NAT (here, NAT 4, 6) at the border between the private and the public address space. The NAT 4, 6 appropriately routed in the private network allocates public IP address to the host originating the path-coupled signaling packet. In such a say, the hosts A and B can use the respectively allocated public IP addresses to communicate with each other. The path determined thus is very likely to be an optimal path between the hosts A and 2 Details of the preferred embodiments will be described with reference to FIGS. 2-4.

### First Embodiment

FIG. 2 shows schematically a first embodiment of the present invention to exchange data between host A—caller and host B—called party. In addition to the two hosts A and B communicating with each other, the figure in the top line shown a SIP proxy 7 and a NAT 4 of the private network of Host A as well as a SIP proxy 8 and a NAT 6 of the private network of Host B. For the NAT 4, 6, it should be assumed that this is the last NAT before the public address space. Since the public address of the SIP proxies 7, 8 is a NAT connection to the respective NATs 4, 6, the SIP proxies 7, 8 each have a real private address and a virtual address which can be accessed from the outside i.e. from the public address space.

In the course of setting up the SIP connection, the host A initially sends a SIP INVITE message to the host B, which replies to this with a SIP Ringing message. The host B then sends a path-coupled signaling packet 16 in the direction to the SIP proxy 7 which is the first proxy described in the first via header of the SIP INVITE message. This first SIP proxy 7 is located within the private network.1 of the caller, 50 that the path-coupled signaling packet 16 is routed in the correct direction and passes the corresponding NAT 6.

On the NAT 6, a public IP address is allocated to the host B and a path-coupled signaling packet 17 is sent back to the host B, which is informed of the allocated public IP address. Thus the call is accepted by the host B as indicated by the dashed arrow labeled C.A. (Call Accepted) in FIG. 2, which is physically equivalent to the host B picking up the telephone receiver.

Then the host B sends a SIP 200 OK message containing IS the recently allocated public target address to the caller host A through the SIF proxies 8, 9, 7 and then the router 10. When having received the SIP 200 OK message, the host A uses the public target address included in the SIP 200 OK message as a destination address to send a path-coupled signaling packet 18. As a reply to the path-coupled signaling packet 19, the host A receives a path-coupled signaling packet 19 from the NAT 4 of its private network 1 optimally routed as described before, so that the host A is informed of a public IF address and port number on the corresponding NAT 4.

The address allocated to the host A is then sent to the host B through a SIP REINVITE packet to inform the host B about the allocated address. Thereafter, the normal SIP signaling is continued and finally the host A and the host B can exchange data with each other through the public target addresses of which they have informed each other.

### Second Embodiment

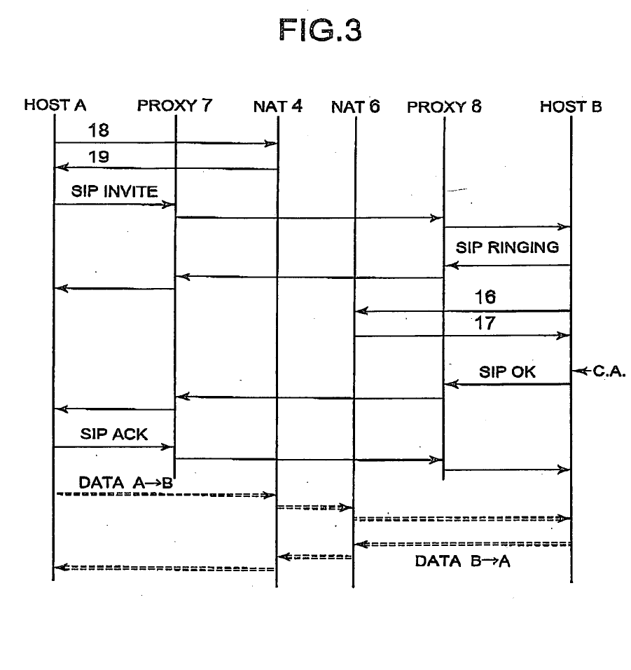

FIG. 3 shows schematically a second embodiment of the present invention, in which the same elements or the same process steps as in FIG. 2 are denoted by the same reference numerals or characters.

According to the second embodiment as shown in FIG. 3, in the first step, the address allocation is carried out immediately on the NAT 4 of the caller—host A. More specifically, a DNS resolution of the SIP name of the desired communication partner—host B—is carried out. The SIP name is allocated to the SIP proxy 8 (corresponding with a public IP address) on which the called party has been registered.

The caller host A sends a path-coupled signaling packet 18 in the direction of the SIP proxy 8, which causes a public address to be allocated to the host A on the NAT 4 of its private network 1.

Subsequently, the host A sends a SIP INVITE message to the host B to inform the host B of the address allocated to the host A Using the public address allocated to the host A, the host B sends a path-coupled signaling packet 16 and in this way the host B specifies a public IP address and port number on its side. The public MP address specified on the host B is sent to the host A through the SIP 200 OK message to inform the host A of this public IP address of the host B. Thereafter, the normal SIP signaling is continued and finally data can be exchanged between the two hosts.

### Third Embodiment

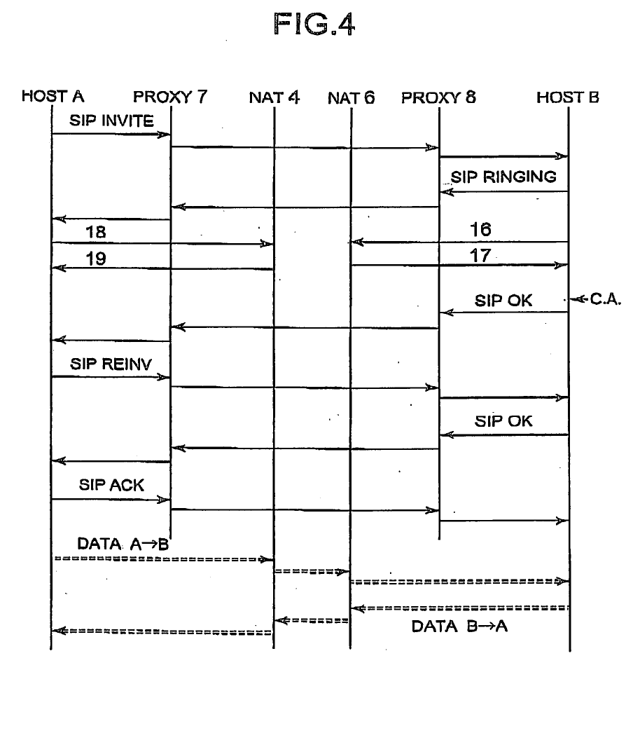

FIG. 4 shows schematically a third embodiment of the present invention, in which the same elements or the same process steps as in FIG. 2 are denoted by the same reference numerals or characters.

According to the third embodiment, the address allocation on the NAT 4 of the caller—host A—is carried out on the basis of the SIP Ringing message. This SIP Ringing packet contains the same via header information as the SIP INVITE message with only the order of the headers being different.

When having received the SIP Ringing message, the host A sends a path-coupled signaling packet 18 to the SIP proxy 8 specified by the last via header of the received SIP Ringing message, which is located topologically near to the host B.

In the third embodiment, a public address has been already allocated to the host A before the host B accepts the call, for example, by picking up the receiver of its Internet telephone. In this way, a fast connection set up is guaranteed. In the case where the host B does not accept the call for example because the host B is in another session or is not present, the address allocation carried out by the host A would be superfluous and would be discarded.

With regard to other advantageous embodiments and developments of the teaching in accordance with the invention, reference is made to the general part of the description and on the other hand to the enclosed patent claims. Finally, it should be particularly noted that the previous randomly selected embodiments solely serve to explain the teaching in accordance with the invention, but not to limit said teaching to said embodiments.

1. A data communication method between two hosts through a public network, wherein the two hosts belong to different private networks having their own private address spaces, wherein each of the private networks includes: at least one network address translator (NAT) performing address translation between a pubic address and a private address; and a proxy server accessible from a public address space, wherein a connection is initialized through the proxy servers between the two hosts by means of predetermined protocols, the method comprising:
sending a path-coupled signaling protocol from each of the two hosts in the direction of the private network's proxy server of the respective other host, with the direction being determined on the basis of information from the protocol to initialize the connection;
allocating a public target address to each host by a NAT of its private network which the path-coupled signaling protocol passes, under which target address the host can receive data from the respective other host; and
informing the other respective host of the public target address by means of the protocol to initialize the connection.

2. The data communication method according to claim 1, wherein Session Initiation Protocol (SIP), Protocol H.323, a similar signaling protocol, or similar application based protocol is used as protocol to initialize the connection on an application basis.

3. The data communication method according to claim 1, wherein SIP proxies are used as proxy servers which are configured so that they use their public address in the SIP Via header.

4. The data communication method according to claim 1, wherein the respective other host also is informed of port numbers in addition to public target addresses.

5. The data communication method according to claim 1, wherein the SIP proxies are located topologically near to the respective hosts.

6. The data communication method according to claim 3, wherein, when a called party receives a SIP INVITE packet, sending a path-coupled Signaling protocol from the called party in the direction of the SIP proxy which is listed in the first via header of the SIP INVITE packet.

7. The data communication method according to claim 6, wherein a public target address is allocated to the called party by a NAT of its private network which the path-coupled signaling protocol has passed.

8. The data communication method according to claim 7, wherein a caller is informed through a SIP 200 OK message of the public target address allocated to the called party.

9. The data communication method according to claim 8, wherein the caller sends a path-coupled signaling protocol in the direction of the called party's public target address said caller was informed of.

10. The data communication method according to claim 9, wherein a public target address is allocated to the caller by a NAT of its private network which the path-coupled signaling protocol has passed.

11. The data communication method according to claim 10, wherein the called party is informed of the public target address allocated to the caller through a SIP re-INVITE message.

12. The data communication method according to claim 11, wherein a SIP 200 OK message and a SIP ACK message are exchanged between the caller and the called party.

13. The data communication method according to claim 12, wherein the caller and the called party exchange data between the public target addresses made known to each other.

14. The data communication method according to claim 3, wherein the caller translates the SIP name of the called party using DNS (Domain Name System) resolution into the public address of the SIP proxy under which the called party is registered and then sends a path-coupled signaling protocol in the direction of this SIP proxy.

15. The data communication method according to claim 14, wherein a public target address is allocated to the caller by a NAT of its private network which the path-coupled signaling protocol has passed.

16. The data communication method according to claim 15, wherein the called party is informed through a SIP INVITE message of the public target address allocated to the caller.

17. The data communication method according to claim 16, wherein the called party sends a path-coupled signaling protocol to the caller's public target address said called party was informed of.

18. The data communication method according to claim 17, wherein a public target address is allocated to the called party by a NAT of its private network, which the path-coupled signaling protocol has passed.

19. The data communication method according to claim 18, wherein the caller is informed through a SIP 200 OK message of the public target address allocated to the called party.

20. The data communication method according to claim 19, wherein a SIP ACK message is sent from the caller to the called party.

21. The data communication method according to claim 20, wherein the caller and the called party exchange data between the public target addresses made known to each other.

22. The data communication method according to claim 3, wherein the caller sends a SIP INVITE packet to the called party and said called party sends back a SIP Ringing packet to the caller.

23. The data communication method according to claim 22, wherein the caller sends a path-coupled signaling protocol in the direction of the SIP proxy which is listed in the last via header of the SIP Ringing packet and the called party sends a path-coupled signaling protocol in the direction of the SIP proxy which Is listed in the first via header of the SIP INVITE packet,

24. The data communication method according to claim 22, wherein respective public target addresses are allocated to the caller and the called party by NATs of their private networks which path-coupled signaling protocols have passed.

25. The data communication method according to claim 24, wherein the caller is informed through a SIP 200 OK message of the public target address allocated to the called party and the called party is informed through a SIP re-INVITE message of the public target address allocated to the caller.

26. The data communication method according to claim 25, wherein a SIP 200 OK and a SIP ACK message are exchanged between the caller and the called party.

27. The data communication method according to claim 26, wherein the caller and the called party exchange data between the public target addresses made known to each other.
